(19) United States
(12) Patent Application Publication
(10) Pub. No.: US 2014/0329151 A1
(43) Pub. Date: Nov. 6, 2014

(54) LITHIUM ION SECONDARY BATTERY AND MANUFACTURING METHOD THEREOF

(71) Applicants: Hiroshi Onizuka, Aichi (JP); Mitsuru Sakano, Aichi (JP); Tomohiro Nakano, Aichi (JP)

(72) Inventors: Hiroshi Onizuka, Aichi (JP); Mitsuru Sakano, Aichi (JP); Tomohiro Nakano, Aichi (JP)

(21) Appl. No.: 14/357,406

(22) PCT Filed: Nov. 10, 2011
(86) PCT No.: PCT/JP2011/006299

§ 371 Date: May 9, 2014

(51) Int. Cl. H01M 4/36; H01M 4/131; B05D 3/10; H01M 4/485; H01M 4/50; H01M 4/525; H01M 4/62; H01M 4/133

(52) U.S. Cl. CPC H01M 4/366; H01M 4/628; H01M 4/131; H01M 4/133; H01M 4/485; H01M 4/502; H01M 4/525; B05D 3/10; B05D 3/107; H01M 2004/027
USPC 429/231.95; 427/77

(57) ABSTRACT

The present invention provides a lithium ion secondary battery capable of improving charge/discharge cycle characteristics or durability such as high-temperature storability, while suppressing deterioration in initial performance, and a manufacturing method thereof. The lithium ion secondary battery according to the present invention includes an electrode serving as a cathode or an anode including an electrode layer containing an active material. At least a part of a surface of the active material is coated with lithium halide (X) having a low ionic bonding property and a peak strength ratio P1/P2 of less than 2.0 between a peak strength P1 in the vicinity of 60 eV and a peak strength P2 in the vicinity of 70 eV in a Li-XAFS measurement.

### TECHNICAL FIELD

The present invention relates to an electrode for a lithium ion secondary battery, and a manufacturing method thereof.

### BACKGROUND ART

A lithium ion secondary battery is generally composed of a cathode including an active material such as a Li-containing composite oxide; an anode including an active material such as carbon; a separator that isolates the cathode and the anode; and a nonaqueous electrolyte including LiPF₆ or the like.

Patent Literature 1 discloses a problem inherent in a conventional lithium ion secondary battery in which when charging and discharging of a lithium ion secondary battery are repeated, LiF generated by side reaction of LiPF₆ used as a nonaqueous electrolyte is irregularly formed on a surface of an anode made of carbon, which deteriorates performance of the battery and shortens the life of the battery (paragraph 0004).

Patent Literature 1 discloses, as means for solving the above-mentioned problem, an anode for a lithium ion secondary battery in which a LiF particle layer is formed on the surface (Claim 1).

Patent Literature 1 discloses that the surface of the anode is preliminarily coated with LiF particles to allow LiF generated by side reaction of LiPF₆ to be uniformly formed on the surface of the anode, thereby elongating the life of the lithium ion secondary battery, though an initial performance is deteriorated to some extent (paragraph 0008).

Patent Literature 2 discloses a cathode active material in which a coating layer containing LiF is formed on a surface of a lithium composite oxide, so as to provide a cathode active material in which a large capacitance and excellent charge/discharge cycle characteristics are obtained and an increase in internal resistance can be suppressed (Claim 4).

Patent Literature 2 discloses that the coating layer suppress the elution of the main transition metal element contained in the cathode active material and suppresses the deterioration of the cycle characteristics (paragraph 0061). Patent Literature 2 also discloses that the halogen element contained in the coating layer reacts to impurities (for example, LiOH or Li₂CO₃) on the surface of the cathode active material and stabilizes the cathode active material (paragraph 0061).

### CITATION LIST

### Patent Literature

[Patent Literature 1] Published Japanese Translation of PCT International Publication for Patent Application, No. 2011-513912
[Patent Literature 2] Japanese Unexamined Patent Application Publication No. 2009-104805

### Non Patent Literature

[Non Patent Literature 1] “Studies of Electric Structure in Material using Ultra Soft X-rays”, Kazuo Taniguchi, Osaka Electro-Communication Univ., Journal (Natural Science) No. 41 (2006)
[Non Patent Literature 2] Physica status solid (b), vol. 134 (1986), pp. 641-650

### SUMMARY OF INVENTION

### Technical Problem

In Patent Literatures 1 and 2, lithium halide is added to an anode active material or a cathode active material. In such a configuration, charge/discharge cycle characteristics or durability such as high-temperature storability can be improved. However, lithium halide inhibits diffusion of Li ions, which results in an increase in initial resistance and deterioration in initial performance.

The present invention has been made in view of the above-mentioned circumstances, and it is an object of the present invention to provide a lithium ion secondary battery capable of improving charge/discharge cycle characteristics or durability such as high-temperature storability, while suppressing deterioration in initial performance, and a manufacturing method thereof.

### Solution to Problem

A lithium ion secondary battery according to the present invention includes an electrode serving as one of a cathode and an anode including an electrode layer containing an active material, in which at least a part of a surface of the active material is coated with lithium halide (X) having a low ionic bonding property and a peak strength ratio P1/P2 of less than 2.0 between a peak strength P1 in the vicinity of 60 eV and a peak strength P2 in the vicinity of 70 eV in a Li-XAFS measurement.

A manufacturing method of a lithium ion secondary battery according to the present invention is a manufacturing method of the above-described lithium ion secondary battery of the present invention, the manufacturing method including: a step (A) of forming the electrode layer containing the active material and lithium halide (Y) having a high ionic bonding property and the peak strength ratio P1/P2 of equal to or more than 2.0 in the Li-XAFS measurement; and a step (B) of performing an aging treatment on the electrode layer at a temperature of 50° C. or higher in a battery charge state to make the lithium halide (Y) having a high ionic bonding property into lithium halide (X) having a low ionic bonding property.

### Advantageous Effects of Invention

According to the present invention, it is possible to provide a lithium ion secondary battery capable of improving charge/discharge cycle characteristics or durability such as high-temperature storability, while suppressing deterioration in initial performance, and a manufacturing method thereof.

### BRIEF DESCRIPTION OF DRAWINGS

FIG. 1 is a graph showing evaluation results of Related-Art Example 1-1, Examples 1-1 to 1-7, and Comparative Examples 1-1 to 1-3; and

FIG. 2 is a graph showing evaluation results of Related-Art Example 2-1, Examples 2-1 to 2-7, and Comparative Examples 2-1 to 2-3.

### DESCRIPTION OF EMBODIMENTS

The present invention will be described in detail below.

The present invention relates to a lithium ion secondary battery and a manufacturing method thereof.

### [Overall Configuration of Lithium Ion Secondary Battery]

First, the general overall configuration of a lithium ion secondary battery will be described.

A lithium ion secondary battery is generally composed of a cathode, an anode, a separator that isolates the cathode and the anode, a nonaqueous electrolyte, an exterior body, and the like.

### <Cathode>

A cathode can be manufactured by coating a cathode active material on a cathode current collector, such as aluminum foil, by a publicly known method.

The cathode active material is not particularly limited. Examples of the cathode active material include lithium-containing composite oxides such as LiCoO₂, LiMnO₂, LiMn₂O₄, LiNiO₂, LiNiₓCo₍₁₋ₓ₎O₂, and LiNiₓCo_{y}Mn_{(1-x-y)}O₂.

For example, the above-mentioned cathode active material, conductive agent such as carbon powder, and binding agent such as polyvinylidene fluoride (PVDF) are mixed using a dispersant such as N-methyl-2-pyrrolidone, thereby obtaining electrode layer-forming paste. This electrode layer-forming paste is coated on a cathode current collector such as aluminum foil, and is then dried and subjected to press working to thereby obtain the cathode.

The mass per unit area of the cathode electrode layer is not particularly limited, but is preferably 1.5 to 15 mg/cm². If the mass per unit area of the cathode electrode layer is excessively small, it is difficult to perform uniform coating. If the mass per unit area of the cathode electrode layer is excessively large, there is a possibility that the cathode electrode layer peels from the current collector.

### <Anode>

The anode active material is not particularly limited, but an anode active material having a lithium occlusion capacity at 2.0 V or lower on the basis of Li/Li+ is preferably used. Examples of the anode active material include carbon such as graphite, metallic lithium, lithium alloy, transition metal oxide/transition metal nitride/transition metal sulfide capable of doping/undoping lithium ions, and combinations thereof.

In lithium ion secondary batteries, carbon material capable of occluding and emitting lithium is widely used as the anode active material. In particular, highly crystalline carbon such as graphite has such characteristics as even discharge potential, high real density, and excellent filling property. For this reason, highly crystalline carbon is used as the anode active material for commercially-available lithium ion secondary batteries in many cases. Accordingly, graphite or the like is particularly preferably used as the anode active material.

For example, the anode can be manufactured by a publicly known method such that an anode active material is coated on an anode current collector such as copper foil.

For example, the above-mentioned anode active material, binding agent such as modified styrene-butadiene copolymer latex, and, as needed, a thickener such as carboxymethylcellulose Na salt (CMC) are mixed using a dispersant such as water, thereby obtaining electrode layer-forming paste. This electrode layer-forming paste is coated on the anode current collector such as copper foil, and is then dried and subjected to press working to thereby obtain the anode.

The mass per unit area of the anode electrode layer is not particularly limited, but 1.5 to 15 mg/cm² is preferable. If the mass per unit area of the anode electrode layer is excessively small, it is difficult to perform uniform coating. If the mass per unit area of the anode electrode layer is excessively large, there is a possibility that the anode electrode layer peels from the current collector.

When metallic lithium or the like is used as the anode active material, metallic lithium or the like can be directly used as the anode.

### <Nonaqueous Electrolyte>

A publicly-known nonaqueous electrolyte can be used, and a liquid, gel-like, or solid nonaqueous electrolyte can be used.

For example, preferably used is a nonaqueous electrolyte obtained by dissolving a lithium-containing solute in a mixture solvent of a carbonate solvent having a high dielectric constant, such as propylene carbonate or ethylene carbonate, and a carbonate solvent having a low viscosity, such as diethyl carbonate, methyl ethyl carbonate, or dimethyl carbonate.

For example, a mixture solvent of ethylene carbonate (EC)/dimethyl carbonate (DMC)/ethyl methyl carbonate (EMC) is preferably used as the mixture solvent.

Examples of the lithium-containing solute include lithium salt such as LiPF₆, LiBF₄, LiClO₄, LiAsF₆, Li₂SiF₆, LiOSO₂CₖF₍₂ₖ₊₁₎ (k is an integer ranging from 1 to 8), and LiPFₙ{CₖF₍₂ₖ₊₁₎}₍₆₋ₙ₎ (n is an integer ranging from 1 to 5, and k is an integer ranging from 1 to 8), and combinations thereof.

### <Separator>

Any film that electrically isolates the cathode and the anode and is capable of transmitting lithium ions may be used. A porous polymer film is preferably used.

As the separator, a porous film made of polyolefin, such as a porous film made of PP (polypropylen), a porous film made of PE (polyethylene), or PP (polypropylen)-PE (polyethylene) laminated porous film is preferably used, for example.

### <Exterior Body>

A publicly-known exterior body can be used.

Examples of the types of secondary batteries include a cylindrical type, a coin type, an angular type, and a film-type. The exterior body can be selected depending on the desired type.

### [Lithium Ion Secondary Battery and Manufacturing Method Thereof]

A lithium ion secondary battery according to the present invention is a lithium ion secondary battery that includes an electrode serving as a cathode or an anode including an electrode layer containing an active material. At least a part of the surface of the active material is coated with lithium halide (X) having a low ionic bonding property and a peak strength ratio P1/P2 of less than 2.0 between a peak strength P1 in the vicinity of 60 eV and a peak strength P2 in the vicinity of 70 eV in a Li-XAFS measurement.

As lithium halide (X), lithium fluoride (LiF), lithium chloride (LiCl), lithium bromide (LiB), lithium iodide (LiI), or the like is preferably used, and lithium fluoride (LiF) or the like is particularly preferably used.

One or two or more types of lithium halide (X) can be used.

In Patent Literatures 1 and 2 cited in the “Background Art” section, lithium halide is added to at least the surface of the anode active material or cathode active material. In such a configuration, charge/discharge cycle characteristics or durability such as high-temperature storability can be improved. However, the lithium halide inhibits diffusion of Li ions, which leads to an increase in initial resistance and deterioration in initial performance.

According to the present invention, the use of lithium halide (X) having a low ionic bonding property enables improvement of the charge/discharge cycle characteristics or durability such as high-temperature storability, while suppressing deterioration in initial performance.

In the lithium ion secondary battery according to the present invention, lithium halide is added to the cathode and/or the anode.

In the case of adding lithium halide to the anode active material, the surface of the anode active material is preliminarily coated with lithium halide, which suppresses self-discharge of the anode in a charge state, or suppresses collapse of the crystal structure of the anode active material due to a battery reaction, for example. For such reasons, the cycle charge-discharge characteristics or durability such as high-temperature storability is considered to be improved.

In the case of adding lithium halide to the cathode active material, elution of a principal transition metal element contained in the cathode active material is suppressed, or a halogen element contained in lithium halide reacts with impurities (for example, excess lithium compounds such as LiOH or Li₂CO₃) of the cathode active material and stabilizes the cathode active material, for example. For such reasons, the cycle charge-discharge characteristics or durability such as high-temperature storability is considered to be improved.

More specifically, it is considered that the addition of lithium halide provides the effect of suppressing elution of manganese of lithium manganese oxide used as the cathode active material, and the effect of stabilizing the crystal structure of lithium-containing cobalt composite oxide of a hexagonal system used as the cathode active material, for example.

It is also considered that the addition of lithium halide suppresses separation of primary particles of a particulate cathode active material, thereby improving the cycle charge-discharge characteristics or durability such as high-temperature storability.

In addition, it is preferable to include a large amount of halogen-containing lithium salt in a nonaqueous electrolyte because halogen-containing lithium salt, such as LiPF₆, contained in nonaqueous electrolyte is mainly involved in the charge and discharge reaction. However, it is difficult to dissolve a large amount of halogen-containing lithium salt in a nonaqueous electrolyte. Accordingly, it is considered that the inclusion of lithium halide in the cathode and/or the anode suppresses deactivation of lithium ions due to the reductive decomposition of the nonaqueous electrolyte, and improves the cycle charge-discharge characteristics or durability such as high-temperature storability.

The peak strength ratio P1/P2 between the peak strength P1 in the vicinity of 60 eV and the peak strength P2 in the vicinity of 70 eV in the Li-XAFS measurement is an index for the ionic bonding property between a lithium atom and a ligand atom in lithium halide.

The peak in the vicinity of 60 eV in the Li-XAFS measurement is a large peak appearing when the ionic bonding property between a lithium atom and a ligand atom is strong. Accordingly, it can be said that as the peak strength ratio P1/P2 increases, the ionic bonding property between the lithium atom and the ligand atom increases. It is considered that lithium halide having a high ionic bonding property between a lithium atom and a ligand atom has a high interaction with lithium ions, and the diffusion of lithium ions is inhibited by the lithium halide, which increases the initial resistance when lithium halide is used for coating of the active material.

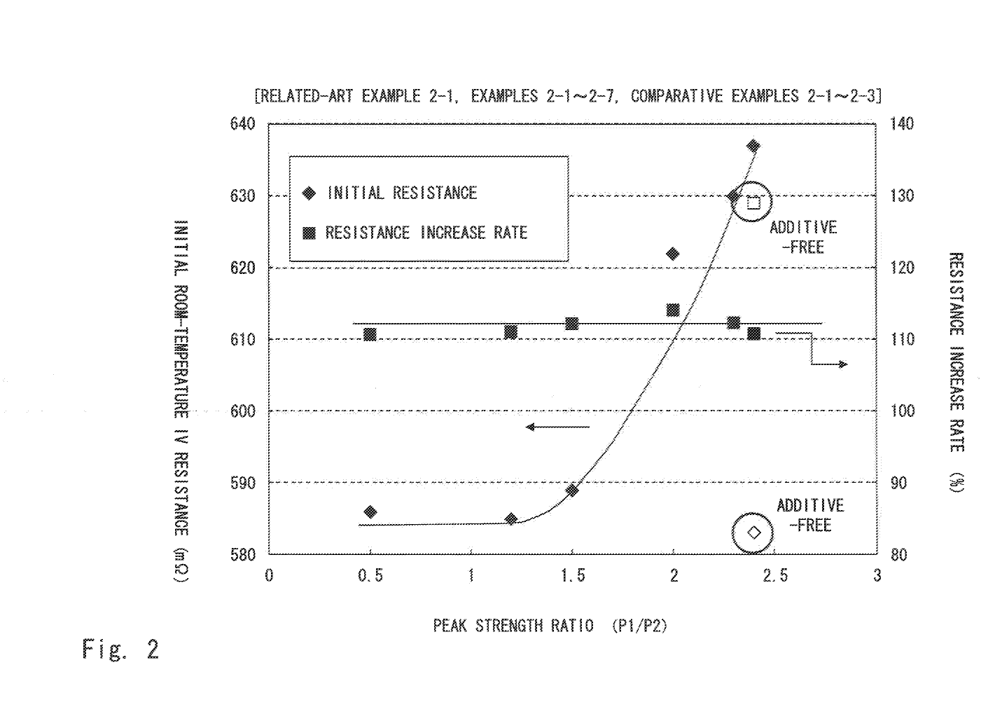

The Li—K absorption edge spectrum of lithium halide on which no particular treatment is performed is described on p. 3 and FIG. 3 of Non Patent Literature 1 and p. 643 and FIG. 2 of Non Patent Literature 2, which are cited in the “Background Art” section, for example.

The peak strength ratio P1/P2 of lithium halide on which no particular treatment is performed is generally equal to or more than 2.0.

It is considered that the use of lithium halide (X) having a low ionic bonding property and having a peak strength ratio P1/P2 of less than 2.0 reduces the interaction between lithium halide and lithium ions and also reduces the inhibition of diffusion of lithium ions due to the lithium halide, thereby suppressing an increase in initial resistance when lithium halide is used for coating of the active material.

The use of lithium halide (X) having a low ionic bonding property and having a peak strength ratio P1/P2 of less than 2.0 suppresses the deterioration in initial performance and improves the charge/discharge cycle characteristics or durability such as high-temperature storability.

The peak strength ratio P1/P2 is preferably 0.5 to 1.5.

For example, an electrode layer including lithium halide (Y), which has a high ionic bonding property and a peak strength ratio P1/P2 of 2.0 or more and on which no particular treatment is performed, is formed. This electrode layer is subjected to an aging treatment at a predetermined temperature or higher, thereby making lithium halide (Y) having a high ionic bonding property into lithium halide (X) having a low ionic bonding property with a peak strength ratio P1/P2 of less than 2.0, and more preferably, 0.5 to 1.5.

In this case, the deterioration in the ionic bonding property of lithium halide due to the aging treatment is a new finding by the present inventors.

A heat treatment in a battery charge state is herein defined as “aging treatment”.

The charge conditions in the “aging treatment” are not particularly limited, but 3 V or higher is preferable.

If the aging treatment temperature is extremely low, the effect of reducing the ionic bonding property of lithium halide cannot be fully obtained. When the aging treatment temperature is 50° C. or higher, the effect of reducing the ionic bonding property of lithium halide is fully obtained, and the initial resistance in the case of using lithium halide for coating of the active material can be sufficiently reduced.

The lithium ion secondary battery according to the present invention can be manufactured by a manufacturing method of a lithium ion secondary battery, the manufacturing method including: a step (A) of forming an electrode layer including an active material and lithium halide (Y) having a high ionic bonding property, the peak strength ration P1/P2 in the Li-XAFS measurement being equal to more than 2.0; and a step (B) of performing an aging treatment on the electrode layer at a temperature of 50° C. or higher in a battery charge state to make lithium halide (Y) having a high ionic bonding property into lithium halide (X) having a low ionic bonding property.

Even when lithium halide is not actively added at the time of formation of the electrode layer, lithium halide is generally supplied to the electrode layer from the nonaqueous electrolyte after the battery assembly.

Accordingly, in the step (A), the electrode layer including an active material and lithium halide (Y) having a high ionic bonding property can be formed by, for example, preparing electrode layer-forming paste without adding lithium halide; coating the electrode layer-forming paste on a current collector and drying the electrode layer-forming paste to form an electrode layer which includes an active material and which includes no lithium halide; assembling the battery using the electrode; and supplying lithium halide (Y) having a high ionic bonding property to the electrode layer from the nonaqueous electrolyte.

In this case, the aging treatment for the electrode layer in the step (B) is carried out after the battery assembly in which the electrode layer contacts the nonaqueous electrolyte and the lithium halide (Y) having a high ionic bonding property is supplied to the electrode layer.

Since it is difficult to increase the concentration of halogen-containing lithium salt contained in the nonaqueous electrolyte, it is more preferable to actively add lithium halide at the time of formation of the electrode layer.

In the step (A), the electrode layer including an active material and lithium halide (Y) having a high ionic bonding property can be formed by, for example, preparing electrode layer-forming paste including an active material and lithium halide (Y) having a high ionic bonding property; and coating the electrode layer-forming paste on a current collector and drying the electrode layer-forming paste. Thus, also in the case of actively adding lithium halide (Y) having a high ionic bonding property at the time of formation of the electrode layer, lithium halide (Y) having a high ionic bonding property is further supplied to the electrode layer from the nonaqueous electrolyte after the battery assembly.

Accordingly, also in this case, the aging treatment for the electrode layer in the step (B) is carried out after the battery assembly in which the electrode layer contacts the nonaqueous electrolyte and the lithium halide (Y) having a high ionic bonding property is supplied to the electrode layer.

If the effect of reducing the ionic bonding property is fully obtained and the energy cost of the aging treatment and the like are taken into consideration, the aging treatment temperature is preferably 50 to 70° C. in the step (B).

The concentration of the lithium halide (X) having a low ionic bonding property in the electrode layer is not particularly limited.

The “concentration of lithium halide in the electrode layer” herein described refers not to a feed ratio at the time of formation of the electrode layer, but to a concentration obtained after the battery assembly in which lithium halide is supplied to the electrode layer from the nonaqueous electrolyte.

As the concentration of lithium halide (X) in the electrode layer increases, the effect of improving the cycle charge-discharge characteristics or durability such as high-temperature storability increases. However, if the concentration is excessively high, there is a possibility that the initial resistance cannot be sufficiently reduced even by using lithium halide (X) having a low ionic bonding property.

Accordingly, the concentration of lithium halide (X) in the electrode layer is determined in consideration of the balance between the effect of improving the cycle charge-discharge characteristics or durability such as high-temperature storability, and the initial resistance.

In the case of applying the active material to the anode including carbon or the like, the concentration of lithium halide (X) in the electrode layer is preferably 0.3 to 1.0 μmol/cm².

When the conditions other than lithium halide in the electrode layer-forming paste are the same, the concentration of lithium halide in the electrode layer is correlated with the concentration of lithium halide in the electrode layer-forming paste.

Examples of the nonaqueous electrolyte to be used include a nonaqueous electrolyte obtained by dissolving LiPF₆, which is lithium salt, as electrolyte at a concentration of 1 mol/L by using a mixed solution of ethylene carbonate (EC)/dimethyl carbonate (DMC)/ethyl methyl carbonate (EMC)=1/1/1 (volume ratio) as a solvent.

For example, in the case of using the above-mentioned nonaqueous electrolyte or the like, which is generally used, the concentration of lithium halide is preferably 0.5 to 1.5 parts by mass with respect to the entire solid content of 100 parts by mass of the electrode layer-forming paste.

When the active material is applied to the cathode containing a lithium-containing transition metal oxide, the concentration of lithium halide (X) in the electrode layer is preferably 0.5 to 2.5 μmol/cm².

When the conditions other than lithium halide in the electrode layer-forming paste are the same also on the cathode side, the concentration of lithium halide in the electrode layer is correlated with the concentration of lithium halide in the electrode layer-forming paste.

For example, in the case of using the above-mentioned nonaqueous electrolyte or the like, which is generally used, the concentration of lithium halide is preferably 0.25 to 1.0 parts by mass with respect to the entire solid content of 100 parts by mass of the electrode layer-forming paste.

As described above, according to the present invention, it is possible to provide a lithium ion secondary battery capable of improving the charge/discharge cycle characteristics or durability such as high-temperature storability, while suppressing the deterioration in initial performance, and a manufacturing method thereof.

### EXAMPLES

Examples and Comparative Examples according to the present invention will be described.

### Related-Art Example 1-1, Examples 1-1 to 1-7, Comparative Examples 1-1 to 1-3

In Related-Art Example 1-1, Examples 1-1 to 1-7, and Comparative Examples 1-1 to 1-3, preparation and evaluation of samples were carried out with regard to the addition of lithium fluoride to an anode active material.

### <Cathode>

A lithium composite oxide of a ternary system represented by a general formula LiMn_{1/3}Co_{1/3}Ni_{1/3}O₂ was used as a cathode active material. The specific surface area of this cathode active material was 1.3 m²/g.

In each example, the above-mentioned cathode active material, acetylene black serving as a conductive agent, and PVDF serving as a binding agent were mixed using N-methyl-2-pyrrolidone as a dispersant, thereby obtaining electrode layer-forming paste.

In each example, the mass ratio among the cathode active material, the conductive agent, and the binding agent was 90:8:2, and the solid content concentration of the electrode layer-forming paste was 50%.

The above-mentioned electrode layer-forming paste was coated by doctor blade method on aluminum foil serving as a current collector, was dried at 150° C. for 30 minutes, and was subjected to press working by a press machine, thereby forming the electrode layer.

The cathode was obtained in the manner as described above. The mass per unit area of the cathode electrode layer was 12 mg/cm², and the density of the cathode electrode layer was 2.2 g/cm³.

### <Anode>

Graphite was used as an anode active material. The specific surface area of this anode active material was 3.5 m²/g.

In Examples 1-1 to 1-7 and Comparative Examples 1-1 to 1-3, the electrode layer-forming paste was obtained such that the above-mentioned anode active material, lithium fluoride, modified styrene-butadiene copolymer latex (SBR) serving as a binding agent, and carboxymethylcellulose Na salt (CMC) serving as a thickener were mixed using water as a dispersant.

Table 1 shows the concentration (mass %) of lithium fluoride in the solid content contained in the electrode layer-forming paste in each example.

In Related-Art Example 1-1, lithium fluoride was not added to the electrode layer-forming paste.

In each example, the mass ratio among the anode active material, the binding agent, and CMC was 98:1:1, and the concentration of the solid content of the electrode layer-forming paste was 45%.

In each example, the obtained electrode layer-forming paste was coated by doctor blade method on copper foil serving as a current collector, was dried at 150° C. for 30 minutes, and was subjected to press working by a press machine, thereby forming the electrode layer.

The anode was obtained in the manner as described above. The mass per unit area of the anode electrode layer was 7.5 mg/cm², and the density of the anode electrode layer was 1.1 g/cm³.

### <Separator>

A commercially-available separator including a porous film made of PE (polyethylene) and having a thickness of 20 μm was prepared.

### <Nonaqueous Electrolyte>

A nonaqueous electrolyte was prepared by dissolving LiPF₆, which is lithium salt, as an electrolyte at a concentration of 1 mol/L by using a mixed solution of ethylene carbonate (EC)/dimethyl carbonate (DMC)/ethyl methyl carbonate (EMC)=1/1/1 (volume ratio) as a solvent.

### <Exterior Body>

A film exterior body with a 15 mAh-class battery capacity was prepared as an exterior body.

### <Manufacturing of Lithium Ion Secondary Battery>

A film-type (laminate-type) lithium ion secondary battery was assembled by a publicly known method using the above-mentioned cathode, anode, separator, nonaqueous electrolyte, and film exterior body. The size of the cathode was 47 mm×45 mm, and the size of the anode was 49 mm×47 mm. A pair of the cathode and the anode was formed.

In Examples 1-1 to 1-7 and Comparative Examples 1-2 to 1-3, an aging treatment was carried out after the battery assembly. Table 1 shows the aging conditions.

### <LiF Concentration of Electrode Layer>

In each example, the battery was disassembled after the assembly of the secondary battery and washed using a solvent EMC. Then, the components of the anode electrode layer were extracted using a water/AN solution, and the LiF concentration of the anode electrode layer (anode electrode layer obtained after the aging treatment in the example in which the aging treatment was carried out) was measured by ICP emission spectral analysis using “ICPS-8100” produced by Shimadzu Corporation.

Also in Related-Art Example 1-1 in which LiF was not added to the electrode layer-forming paste of the anode, the LiF concentration of the electrode layer was detected because LiF was supplied to the electrode layer from the electrolyte.

Table 1 shows the results.

There was a tendency that the concentration of lithium fluoride in the anode electrode layer increases as the concentration of lithium fluoride in the electrode layer-forming paste increases.

### <Li-XAFS Measurement>

In each example, the battery was disassembled after the assembly of the secondary battery and was washed using a solvent EMC, and the LiF measurement of the anode electrode layer (anode electrode layer obtained after the aging treatment in the example in which the aging treatment was carried out) was carried out.

In the measurement, the battery was disassembled in a glove box, the dew point of which was controlled, so as to suppress degradation of each sample due to moisture. The measurement was carried out at Kyushu Synchrotron Light Research Center established by Saga Prefecture.

Table 1 shows the measurement results of the peak strength ratio P1/P2 between the peak strength P1 in the vicinity of 60 eV and the peak strength P2 in the vicinity of 70 eV in the Li-XAFS measurement.

In Related-Art Example 1-1 in which LiF was not added to the electrode layer-forming paste, Comparative Example 1-1 in which the aging treatment for the electrode layer was not carried out even when LiF was added to the electrode layer-forming paste, and Comparative Examples 1-2 to 1-3 in which the aging treatment temperature was lower than 50° C. even when LiF was added to the electrode layer-forming paste, P1/P2≧2.0 was obtained. In these examples, lithium fluoride contained in the electrode layer showed a high ionic bonding property.

In Examples 1-1 to 1-7 in which LiF was added to the electrode layer-forming paste and the aging treatment temperature was 50° C. or higher, 0.5≦P1/P2≦1.5 was obtained. In these examples, lithium fluoride contained in electrode layer showed a low ionic bonding property.

### <Initial Resistance>

As an initial room-temperature IV resistance, the IV resistance was measured for 10 sec under the conditions of a temperature of 25° C. and SOC of 50%. Specifically, each battery was caused to discharge for 10 sec at a discharge rate of 1 C, and a resistance value was calculated from a voltage drop obtained at this time.

<Initial Capacity, Capacity after High-Temperature Storage Test, and Capacity Maintenance Factor>

For the lithium ion secondary batteries obtained in each example, a high-temperature storage test was carried out in which each lithium ion secondary battery was stored for 30 days under the conditions of a temperature of 60° C. and SOC of 80%.

Each of the initial discharge capacity and the discharge capacity obtained after the high-temperature storage test was measured as a battery capacity, and the capacity maintenance factor defined as the following formula was obtained.

capacity maintenance factor(%)=(discharge capacity obtained after high-temperature storage test)/(initial discharge capacity)

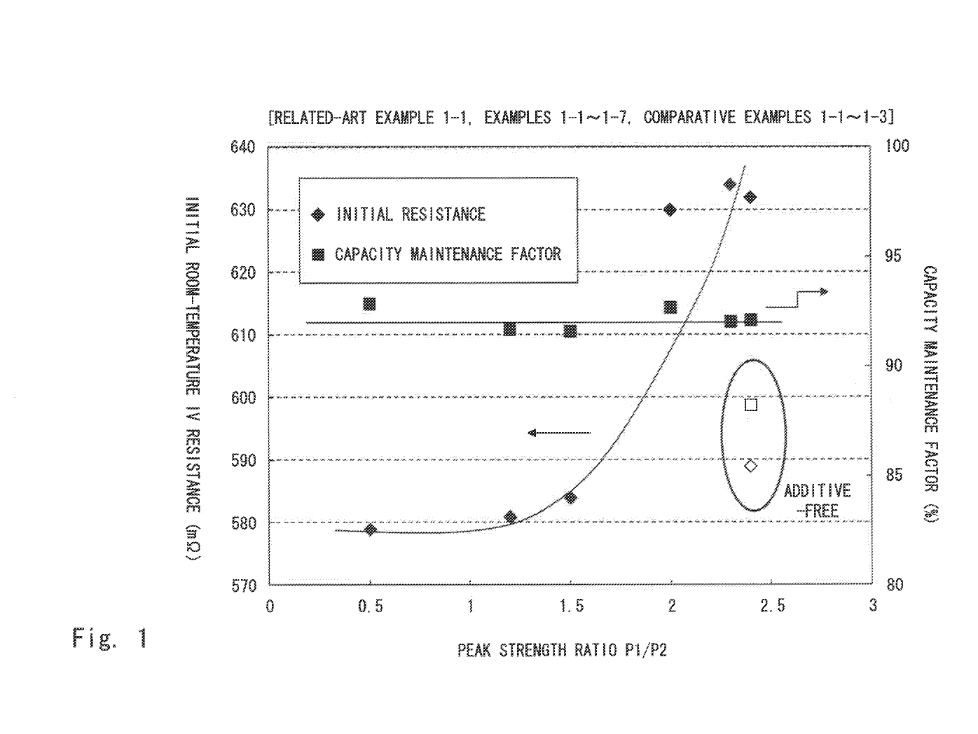

Table 2 and FIG. 1 show the results.

In Examples 1-1 to 1-7 in which lithium fluoride having a low ionic bonding property and the peak strength ratio P1/P2 of 0.5 to 1.5 between the peak strength P1 in the vicinity of 60 eV and the peak strength P2 in the vicinity of 70 eV in the Li-XAFS measurement was added to the anode electrode layer, the following results were obtained. That is, the high-temperature storability was improved and the capacity maintenance factor was improved as compared with Related-Art Example 1-1, and the initial resistance was reduced as compared with Comparative Examples 2-1 to 2-3.

Particularly, in Examples 1-1 to 1-5 in which the concentration of lithium fluoride having a low ionic bonding property in the electrode layer was 0.3 to 1.0 μmol/cm², the effect of improving the high-temperature storability and the effect of reducing the initial resistance were remarkable.

In Example 1-6 in which the concentration of lithium fluoride in the electrode layer was minimum even when lithium fluoride having a low ionic bonding property was added to the anode electrode layer, the effect of reducing the initial resistance was fully obtained, but the effect of improving the high-temperature storability was relatively small as compared with the other examples. In Example 1-7 in which the concentration of lithium fluoride in the electrode layer was maximum even when lithium fluoride having a low ionic bonding property was added to the anode electrode layer, the high-temperature storability was improved most, but the effect of reducing the initial resistance was relatively small as compared with the other examples.

TABLE 1

| | LiF | | | | LiF in |
|---|---|---|---|---|---|
| | concen- | Aging | | | electrode |
| | tration | conditions | | | layer |
| | in paste | Temperature | Time | | Concentration |
| | (%) | (° C.) | (h) | P1/P2 | (μmol/cm²) |
| Related-Art | 0 | — | — | 2.4 | 0.15 |
| Example 1-1 | | | | | |
| Example 1-1 | 0.35 | 50 | 24 | 1.5 | 0.52 |
| Example 1-2 | 0.35 | 60 | 24 | 1.2 | 0.52 |
| Example 1-3 | 0.35 | 70 | 24 | 0.5 | 0.51 |
| Example 1-4 | 0.20 | 60 | 24 | 1.1 | 0.30 |
| Example 1-5 | 0.70 | 60 | 24 | 1.2 | 1.00 |
| Example 1-6 | 0.15 | 60 | 24 | 1.2 | 0.16 |
| Example 1-7 | 1.00 | 60 | 24 | 1.2 | 1.50 |
| Comparative | 0.35 | — | — | 2.4 | 0.52 |
| Example 1-1 | | | | | |
| Comparative | 0.35 | 30 | 24 | 2.3 | 0.53 |
| Example 1-2 | | | | | |
| Comparative | 0.35 | 40 | 24 | 2.0 | 0.51 |
| Example 1-3 | | | | | |

TABLE 2

| | | | | Capacity |
|---|---|---|---|---|
| | Initial | Initial | Capacity after | maintenance |
| | resistance | capacity | durability test | factor |
| | (mΩ) | (mAh) | (mAh) | (%) |
| Related-Art | 589 | 14.76 | 13.02 | 88.2 |
| Example 1-1 | | | | |
| Example 1-1 | 584 | 14.79 | 13.55 | 91.6 |
| Example 1-2 | 581 | 14.81 | 13.58 | 91.7 |
| Example 1-3 | 579 | 14.75 | 13.70 | 92.9 |
| Example 1-4 | 575 | 14.77 | 13.55 | 91.7 |
| Example 1-5 | 582 | 14.82 | 13.75 | 92.8 |
| Example 1-6 | 581 | 14.81 | 13.19 | 89.1 |
| Example 1-7 | 612 | 14.74 | 13.74 | 93.2 |
| Comparative | 632 | 14.74 | 13.58 | 92.1 |
| Example 1-1 | | | | |
| Comparative | 634 | 14.72 | 13.55 | 92.1 |
| Example 1-2 | | | | |
| Comparative | 630 | 14.67 | 13.60 | 92.7 |
| Example 1-3 | | | | |

### Related-Art Example 2-1, Examples 2-1 to 2-7, Comparative Examples 2-1 to 2-3

In Related-Art Example 2-1, Examples 2-1 to 2-7, and Comparative Examples 2-1 to 2-3, preparation and evaluation of samples were carried out with regard to the addition of lithium fluoride to a cathode active material.

### <Cathode>

A lithium composite oxide of a ternary system represented by a general formula LiMn_{1/3}Co_{1/3}Ni_{1/3}O₂ was used as a cathode active material. The specific surface area of this cathode active material was 1.3 m²/g.

In Examples 2-1 to 2-7 and Comparative Examples 2-1 to 2-3, the above-mentioned cathode active material, lithium fluoride, acetylene black serving as a conductive agent, and PVDF serving as a binding agent were mixed using N-methyl-2-pyrrolidone as a dispersant, thereby obtaining electrode layer-forming paste.

Table 3 shows the concentration (mass %) of lithium fluoride in the electrode layer-forming paste in each example.

In Related-Art Example 2-1, lithium fluoride was not added to the electrode layer-forming paste.

In each example, the mass ratio among the cathode active material, the conductive agent, and the binding agent was 90:8:2, and the concentration of the solid content of the electrode layer-forming paste was 50%.

The above-mentioned electrode layer-forming paste was coated by doctor blade method on aluminum foil serving as a current collector, was dried at 150° C. for 30 minutes, and was subjected to press working by a press machine, thereby forming the electrode layer.

The cathode was obtained in the manner as described above. The mass per unit area of the cathode electrode layer was 12 mg/cm², and the density of the cathode electrode layer was 2.2 g/cm³.

### <Anode>

Graphite was used as an anode active material. The specific surface area of this anode active material was 3.5 m²/g.

In each example, the above-mentioned anode active material, modified styrene-butadiene copolymer latex (SBR) serving as a binding agent, and carboxymethylcellulose Na salt (CMC) serving as a thickener were mixed using water as a dispersant, thereby obtaining electrode layer-forming paste.

In each example, the mass ratio among the anode active material, the binding agent, and CMC was 98:1:1, and the concentration of the solid content of the electrode layer-forming paste was 45%.

In each example, the obtained electrode layer-forming paste was coated by doctor blade method on copper foil serving as a current collector, was dried at 150° C. for 30 minutes, and was subjected to press working by a press machine, thereby forming the electrode layer.

The anode was obtained in the manner as described above. The mass per unit area of the anode electrode layer was 7.5 mg/cm², and the density of the anode electrode layer was 1.1 g/cm³.

### <Manufacturing of Lithium Ion Secondary Battery>

A lithium ion secondary battery was assembled by a publicly known method using the above-mentioned cathode and anode, as well as the separator, nonaqueous electrolyte, and exterior body, which are identical with those used in Examples 1-1 to 1-7.

In Examples 2-1 to 2-7 and Comparative Examples 2-2 to 2-3, an aging treatment was carried out after the battery assembly. Table 3 shows the aging conditions.

<LiF Concentration of Electrode Layer>

As in Examples 1-1 to 1-7, the battery was disassembled after the assembly of the secondary battery assembly and the LiF concentration of the cathode electrode layer (cathode electrode layer obtained after the aging treatment in the example in which the aging treatment was carried out) was measured in each example.

Also in Related-Art Example 2-1 in which LiF was not added to the electrode layer-forming paste of the cathode, the LiF concentration of the electrode layer was detected because LiF was supplied to the electrode layer from the electrolyte.

Table 3 shows the results.

There was a tendency that the concentration of lithium fluoride in the cathode electrode layer increases as the concentration of lithium fluoride in the electrode layer-forming paste increases.

### <Li-XAFS Measurement>

As in Examples 1-1 to 1-7, the battery was disassembled after the assembly of the second battery and a Li-XAFS measurement for the cathode electrode layer (cathode electrode layer obtained after the aging treatment in the example in which the aging treatment was carried out) was carried out in each example.

Table 3 shows the measurement results of the peak strength ratio P1/P2 between the peak strength P1 in the vicinity of 60 eV and the peak strength P2 in the vicinity of 70 eV in the Li-XAFS measurement.

In Related-Art Example 2-1 in which LiF was not added to the electrode layer-forming paste, Comparative Example 2-1 in which the aging treatment for the electrode layer was not carried out even when LiF was added to the electrode layer-forming paste, and Comparative Examples 2-2 to 2-3 in which the aging treatment temperature was lower than 50° C. even when LiF was added to the electrode layer-forming paste, P1/P2≧2.0 was obtained. In these examples, lithium fluoride contained in the electrode layer showed a high ionic bonding property.

In Examples 2-1 to 2-7 in which LiF was added to the electrode layer-forming paste and the aging treatment temperature was 50° C. or higher, 0.5≦P1/P2≦1.5 was obtained. In these examples, lithium fluoride contained in the electrode layer showed a low ionic bonding property.

### <Resistance and Resistance Increase Rate>

For the lithium ion secondary batteries obtained in each example, a change in room-temperature IV resistance when each secondary battery was stored for 30 days under the conditions of a temperature of 60° C. and SOC of 80% was measured.

The IV resistance was measured for 10 sec as the room-temperature IV resistance. Specifically, each battery was caused to discharge for 10 sec at a discharge rate of 1 C, and a resistance value was calculated from a voltage drop obtained at this time.

The initial room-temperature IV resistance (IV resistance for 10 sec) and the room-temperature IV resistance (IV resistance for 10 sec) obtained after the high-temperature storage test for 30 days were measured to thereby obtain a resistance increase rate.

Table 4 and FIG. 2 show the results.

In Examples 2-1 to 2-7 in which lithium fluoride having a low ionic bonding property and the peak strength ratio P1/P2 of 0.5 to 1.5 between the peak strength P1 in the vicinity of 60 eV and the peak strength P2 in the vicinity of 70 eV in the Li-XAFS measurement was added to the cathode electrode layer, the following results were obtained. That is, the resistance increase rate in the high-temperature storage test was reduced as compared with Related-Art Example 2-1, and the initial resistance was reduced as compared with Comparative Examples 2-1 to 2-3.

Particularly, in Examples 2-1 to 2-5 in which the concentration of lithium fluoride having a low ionic bonding property in the electrode layer was 0.5 to 2.5 μmol/cm², the effect of improving the high-temperature storability and the effect of reducing the initial resistance were remarkable.

In Example 2-6 in which the concentration of lithium fluoride in the electrode layer was minimum even when lithium fluoride having a low ionic bonding property was added to the cathode electrode layer, the effect of improving the high-temperature storability and the effect of reducing the initial resistance were relatively small as compared with the other examples. In Example 2-7 in which the concentration of lithium fluoride in the electrode layer was maximum even when lithium fluoride having a low ionic bonding property was added to the cathode electrode layer, the effect of improving the high-temperature storability was fully obtained, but the effect of reducing the initial resistance was relatively small as compared with the other examples.

TABLE 3

| | LiF | | | | LiF |
|---|---|---|---|---|---|
| | concen- | Aging | | | concentration |
| | tration | conditions | | | in electrode |
| | in paste | Temperature | Time | | layer |
| | (%) | (° C.) | (h) | P1/P2 | (μmol/cm²) |
| Related-Art | 0 | — | — | 2.4 | 0.10 |
| Example 2-1 | | | | | |
| Example 2-1 | 0.25 | 50 | 24 | 1.5 | 0.49 |
| Example 2-2 | 0.25 | 60 | 24 | 1.2 | 0.53 |
| Example 2-3 | 0.25 | 70 | 24 | 0.5 | 0.51 |
| Example 2-4 | 0.45 | 60 | 24 | 1.2 | 1.10 |
| Example 2-5 | 1.00 | 60 | 24 | 1.3 | 2.30 |
| Example 2-6 | 0.10 | 60 | 24 | 1.2 | 0.15 |
| Example 2-7 | 1.50 | 60 | 24 | 1.2 | 3.10 |
| Comparative | 0.25 | — | — | 2.4 | 0.51 |
| Example 2-1 | | | | | |
| Comparative | 0.25 | 30 | 24 | 2.3 | 0.54 |
| Example 2-2 | | | | | |
| Comparative | 0.25 | 40 | 24 | 2.0 | 0.52 |
| Example 2-3 | | | | | |

TABLE 4

| | | | Resistance |
|---|---|---|---|
| | Initial | Resistance after | increase |
| | resistance | durability test | rate |
| | (mΩ) | (mAh) | (%) |
| Related-Art | 583 | 752 | 129 |
| Example 2-1 | | | |
| Example 2-1 | 589 | 661 | 112 |
| Example 2-2 | 585 | 650 | 111 |
| Example 2-3 | 586 | 649 | 111 |
| Example 2-4 | 583 | 651 | 112 |
| Example 2-5 | 580 | 655 | 113 |
| Example 2-6 | 581 | 694 | 119 |
| Example 2-7 | 611 | 683 | 112 |
| Cornparative | 637 | 706 | 111 |
| Example 2-1 | | | |
| Comparative | 630 | 708 | 112 |
| Example 2-2 | | | |
| Comparative | 622 | 710 | 114 |
| Example 2-3 | | | |

### INDUSTRIAL APPLICABILITY

The lithium ion secondary battery according to the present invention can be preferably applied to lithium ion secondary batteries that are mounted in a plug-in hybrid vehicle (PHV) or an electric vehicle (EV), for example.

1. A lithium ion secondary battery comprising an anode including an electrode layer containing an active material,
wherein a concentration of lithium halide (X) in the electrode layer is 0.3 to 1.0 μmol/m², and
wherein at least a part of a surface of the active material is coated with lithium halide (X) having a low ionic bonding property and a peak strength ratio P1/P2 of less than 2.0 between a peak strength P1 in the vicinity of 60 eV and a peak strength P2 in the vicinity of 70 eV in a Li-XAFS measurement.

2. A lithium ion secondary battery comprising a cathode including an electrode layer containing an active material,
wherein a concentration of lithium halide (X) in the electrode layer is 0.5 to 2.5 μmol/cm², and
wherein at least a part of a surface of the active material is coated with lithium halide (X) having a low ionic bonding property and a peak strength ratio P1/P2 of less than 2.0 between a peak strength P1 in the vicinity of 60 eV and a peak strength P2 in the vicinity of 70 eV in a Li-XAFS measurement.

3. The lithium ion secondary battery according to claim 1, wherein the peak strength ratio P1/P2 in the Li-XAFS measurement of the lithium halide (X) is 0.5 to 1.5.

4. The lithium ion secondary battery according to claim 1, wherein the lithium halide (X) is lithium fluoride.

5. A manufacturing method of a lithium ion secondary battery according to claim 1, comprising:
a step (A) of forming the electrode layer containing the active material and lithium halide (Y) having a high ionic bonding property and the peak strength ratio P1/P2 of equal to or more than 2.0 in the Li-XAFS measurement; and
a step (B) of performing an aging treatment on the electrode layer at a temperature of 50° C. or higher in a battery charge state to make the lithium halide (Y) having a high ionic bonding property into lithium halide (X) having a low ionic bonding property.

6. The manufacturing method of a lithium ion secondary battery according to claim 5, wherein in the step (B), the aging treatment is performed at a temperature of 50 to 70° C.

7. (canceled)

8. The lithium ion secondary battery according to claim 2, wherein the peak strength ratio P1/P2 in the Li-XAFS measurement of the lithium halide (X) is 0.5 to 1.5.

9. The lithium ion secondary battery according to claim 2, wherein the lithium halide (X) is lithium fluoride.

10. A manufacturing method of a lithium ion secondary battery according to claim 2, comprising:
a step (A) of forming the electrode layer containing the active material and lithium halide (Y) having a high ionic bonding property and the peak strength ratio P1/P2 of equal to or more than 2.0 in the Li-XAFS measurement; and
a step (B) of performing an aging treatment on the electrode layer at a temperature of 50° C. or higher in a battery charge state to make the lithium halide (Y) having a high ionic bonding property into lithium halide (X) having a low ionic bonding property.

11. The manufacturing method of a lithium ion secondary battery according to claim 10, wherein in the step (B), the aging treatment is performed at a temperature of 50 to 70° C.
